(19) United States
(12) Patent Application Publication
(10) Pub. No.: US 2016/0063559 A1
(43) Pub. Date: Mar. 3, 2016

(54) Method and Apparatus for Mobile Link to Advertising Content

(71) Applicants: Cary Hargrove, Irving, TX (US); David Tomecko, Dallas, TX (US)

(72) Inventors: Cary Hargrove, Irving, TX (US); David Tomecko, Dallas, TX (US)

(21) Appl. No.: 14/833,289

(22) Filed: Aug. 24, 2015

Related U.S. Application Data
(60) Provisional application No. 62/043,225, filed on Aug. 28, 2014.

(51) Int. Cl. G06Q 30/02; H04W 4/02

(52) U.S. Cl. CPC G06Q 30/0261; G06Q 30/0267; H04W 4/02

(57) ABSTRACT

A method and apparatus for accessing advertising content from a mobile device provides for establishing a link to a content server using location coordinates from a GPS receiver in the mobile device and a brief, simple code, for example composed of only two alpha and/or numeric characters displayed in a billboard advertisement and associated with the content server. Entering the code enables a link to the content server to obtain additional content for download to the mobile device.

### CROSS REFERENCE TO RELATED APPLICATIONS

The present application claims priority to U.S. Provisional Patent Application Ser. No. 62/043,225 filed Aug. 28, 2014 by the same inventors entitled METHOD AND APPARATUS FOR MOBILE LINK TO ADVERTISING CONTENT.

### BACKGROUND OF THE INVENTION

1. Field of the Invention

The present invention generally relates to consumer response to advertising and more particularly to accessing content related to billboard display ads of a billboard advertiser via a consumer mobile device.

2. Background of the Invention and Description of the Prior Art

Typical methods of access to display advertisements such as seen on billboards and other roadside media include use of a telephone number or Internet or email address that appears in the advertisement. Contact information such as these examples involve numerous characters—numeric or alpha—that because of their length are difficult to memorize, particularly when passing such advertisements in a moving vehicle. It is especially difficult for the driver of such vehicle to remember and record such contact information while driving by the advertisement. Some advertisements include logos or QR codes that can be scanned using appropriate devices. However, these access points, while well-suited to magazines or display advertisements on other published media are not well adapted to use on billboards because of the distance involved between the consumer and the billboard and the fact that the consumer is typically in a moving vehicle. These conditions require the ability to resolve a very small portion of the advertisements at a distance from a moving vehicle, which while technically feasible, would be prohibitively expensive for consumer uses and may involve limitations to fair weather, slower speeds, light traffic on the roadway, etc.

Various schemes have been proposed to address the problem of convenient access to display ads such as appear on billboards and the like. One example is disclosed in U.S. Patent Application Publication No. 2011/0124318 A1 filed by Ayer. A service provider, having a database of advertisements supplied by vendors and identified by some form of identifier or code that is never described or defined, responds to customer entry of an “icon and/or” identifier for advertisements of interest within a specified search zone, or according to other search parameters. This system has the disadvantages of being complex and lacking simple, direct access to individual advertisers. There is no enabling disclosure of the form of the identifier or code that ensures simplicity and safety of operation for a user in motion relative to the advertisement, a crucial deficiency in this reference.

What is needed is a simple and reliable method and system for accessing sufficient information displayed on a billboard advertisement from a moving vehicle in real time that is simple and quick to use that also minimizes distractions to the driver of the vehicle, yet permits a quick link to the sponsor or entity providing the advertising to obtain additional information.

### SUMMARY OF THE INVENTION

Accordingly there is provided in one embodiment a user-centric method for accessing advertising content displayed on a billboard panel from a user's mobile communication device having a GPS receiver, comprising the steps of launching an application program installed on the mobile communications device for establishing a link to a content server; accessing location coordinates for the mobile communications device provided from the GPS receiver in the mobile communications device; entering a code, composed of less than five alpha and/or numeric characters displayed in a billboard panel advertisement and associated with the content server, into the user mobile device; associating the code with the location coordinates of the mobile communications device and a URL of an advertiser associated with the advertising content displayed on the billboard panel; connecting the mobile communications device to a content server linked to the advertiser using the URL associated with the code and location coordinates; and downloading content associated with the code from the content server linked to the advertiser to the mobile communications device.

In another embodiment, there is provided an apparatus for accessing advertising content of an advertiser associated with a code displayed in a advertisement on a billboard panel, comprising a mobile communications device having a GPS receiver for obtaining location coordinates and an entry device for entering the code; and an application installed on the mobile communications device for enabling use of the mobile communications device by a user to respond to entry of the code, to form an address string including the location coordinates, the code, and a URL of a content server associated with the code, the address string provided to enable the mobile communication device to access the content server on a network associated with the advertiser; wherein entry of the code initiates an operation to download the content associated with the code from the content server for display on the mobile communications device; and wherein the code is limited to less than five alphabetic or numeric characters.

### BRIEF DESCRIPTION OF THE DRAWINGS

FIG. 1 illustrates a block diagram of one embodiment of a system for operating the present invention; and

FIG. 2 illustrates a flow chart diagram of one embodiment of the process performed by the system of the present invention illustrated in FIG. 1.

### DETAILED DESCRIPTION OF THE INVENTION

The present invention provides an advance in the state of the art of enabling quick access from a mobile communications device that is in motion, for example, to detailed content related to advertising displays on billboard panels of all kinds. Briefly and generally, a billboard panel displaying an advertisement preferably includes a simple, very brief code typically formed of a small number of numeric or alphabetic characters. The code is configured so that it can be quickly perceived by a user of a mobile device who is passing by a billboard panel containing a displayed advertisement. The user's mobile device, in one embodiment, includes a software application for processing the code when it is entered into the user mobile device.

The user mobile device, such as a cell phone, smart phone, laptop or tablet computer, etc., or any other mobile device that is programmable, may also preferably include a UPS receiver to determine its exact location when the code is entered. The code, along with the UPS coordinates of the user mobile device and a URL of a link to a content server associated with the advertiser (for example, associated with the code in a directory in the software application installed on the user mobile device) may be transmitted to the content server. The server may then respond by sending additional information about the product or service or information in the displayed advertisement to the user mobile device that is related to the code symbol that appeared on the billboard panel.

The following description of at least one embodiment is provided for illustration of the concept embodied in the invention but is representative of a number of possible implementations that employ the concept illustrated herein. For purposes of the following description the term billboard panel may generally mean but is not limited to a panel upon which an advertisement is displayed or affixed wherein the panel may be mounted on a stationary object such as a stand alone billboard structure or the wall of a building, other objects that may be in motion such as vehicles of all kinds, or even visual displays having static or moving images. A user mobile device generally means a communications or computing device having an integrated display, means such as a keyboard (mechanical keys or an image displayed on a touch screen, for example) or voice recognition capability for entering numeric and alphabetic characters or other coded information or symbols, and capable of executing software programs, and interfacing with and communicating via wireless link with other similar devices on a network such as the Internet. A content server generally refers to a server that acts as a resource for providing content when a user enters the code displayed in the billboard advertisement. This content server may be provided by a service provider or third party, or even be associated with an advertiser. Fees, for example, for accessing and use of the content may be paid by the advertiser to the provider of the content server resource.

The user in the system of the present invention may typically be a person passing in the vicinity of a billboard advertisement, whose attention is drawn to the advertisement, and who desires to obtain additional information about the content or the subject matter of the advertisement without stopping to write down contact information to request further content. The user may be a consumer or a business person who has in his or her possession a user mobile device as described herein.

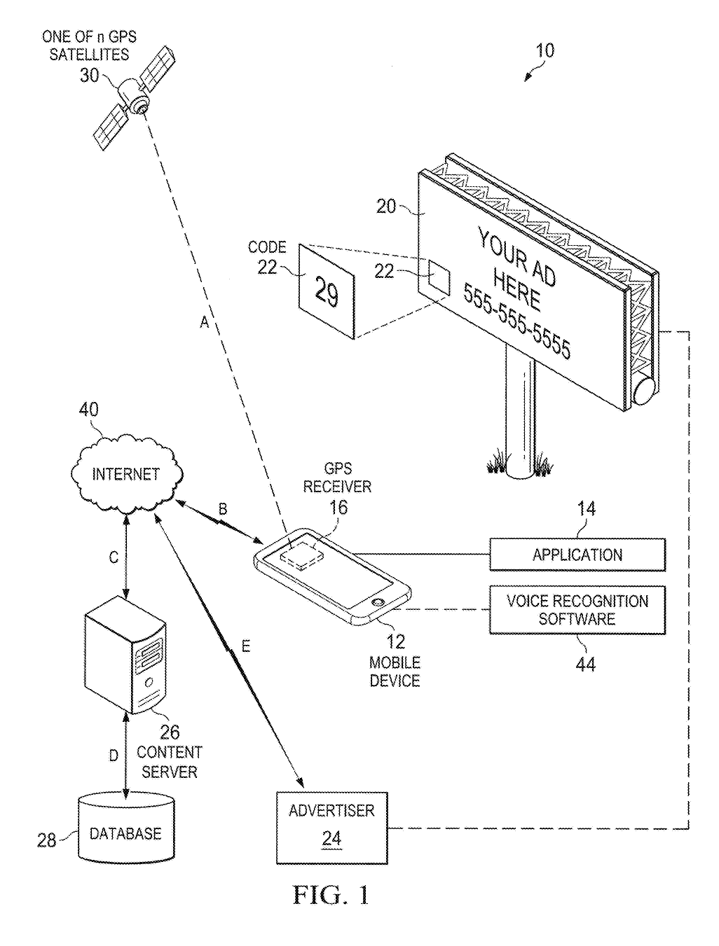

FIG. 1 illustrates a block diagram of one embodiment of a system in which the present invention may operate, The system 10 includes a consumer's or user's mobile communications device configured according to the present invention (“user mobile device 12”) for interacting with a billboard panel 20 that displays an advertisement, with a GPS satellite system for obtaining location coordinates, and with a network such as the Internet. A GPS satellite 30 represents one of a plurality of orbiting Global Positioning Satellites that enable precise location of devices containing a GPS receiver, as will be described. An advertiser 24 and a content server 26 and database 28 are also shown with the ability to connect via a global communications network such as the Internet 40.

The user mobile device 12 preferably includes a GPS receiver 16 capable of accessing the GPS system satellites 30 via the link indicated by a dashed line A and receiving coordinate information containing the location and time stamp data for the user mobile device 12. The user mobile device 12 further preferably includes an application program (“application 14”) that controls the operation of the user mobile device 12. The application 14 contains a number of features for prompting the user through the use of the invention, entering and processing the code 22, constructing or obtaining a URL (or similar) address from a directory to connect the user to the content server 26 via the Internet 40, the selection of content, how the content is received and processed, etc., all of which will be described herein. In an optional embodiment, the user mobile device 12 may include a voice recognition module 44 (or application 44) for receiving voice entry of code 22. The voice recognition module 44 may be called from the application 14 in such embodiments, as will be described.

The GPS receiver 16 may be operative at all times when the mobile device 12 is active or operated only when specifically initiated by the application 14 or other control mechanism. The user mobile device 12 is capable of communication with the Internet 40 via the link B, which may preferably be wireless as shown, under the control of a standard communications interface (not shown) within the mobile device 12.

The advertiser 24 provides the advertisement displayed on the billboard 20. The advertisement preferably includes a code 22 on some portion of the billboard advertisement. As will be described, the advertiser may also provide a URL of its server, wherein the URL may be associated with the code 22 in a directory, for example. when the application 14 described herein is made available to a user by a service that utilizes the present invention. The code 22 is preferably a small number of characters, and perhaps is also associated with a logo symbol representative of a service provider or third party to alert a user of a mobile device equipped with the application 14 that a sponsor of a billboard ad is a participant in the coded download of content. The logo may also be representative of the advertiser 24. The logo symbol may be a trademark or trade name or icon.

Other kinds of code symbols may be used within the proviso that the code 22 must be simple, very short, and easy to remember. It is critical to the utility of the present invention that the code 22 be short, expressed in symbols that are readily recognized at a glance, and displayed in a prominent location and of sufficient size to be visually captured by a user in a momentary glance. While the illustrated example of the code 22 is the (preferred) combination of two numeric characters, any combination of individual numeric or alphabetic characters from any language, in any font, may be used. However, it will be appreciated that fewer characters rather than many, that are easily read and typed by some form of input device such as a keyboard or keypad, whether actual or virtual, will be easier to enter into the user mobile device for the purposes to be described. In some embodiments, the code may be spoken and interpreted by voice recognition software or other similar mechanism to input the code into the user mobile device.

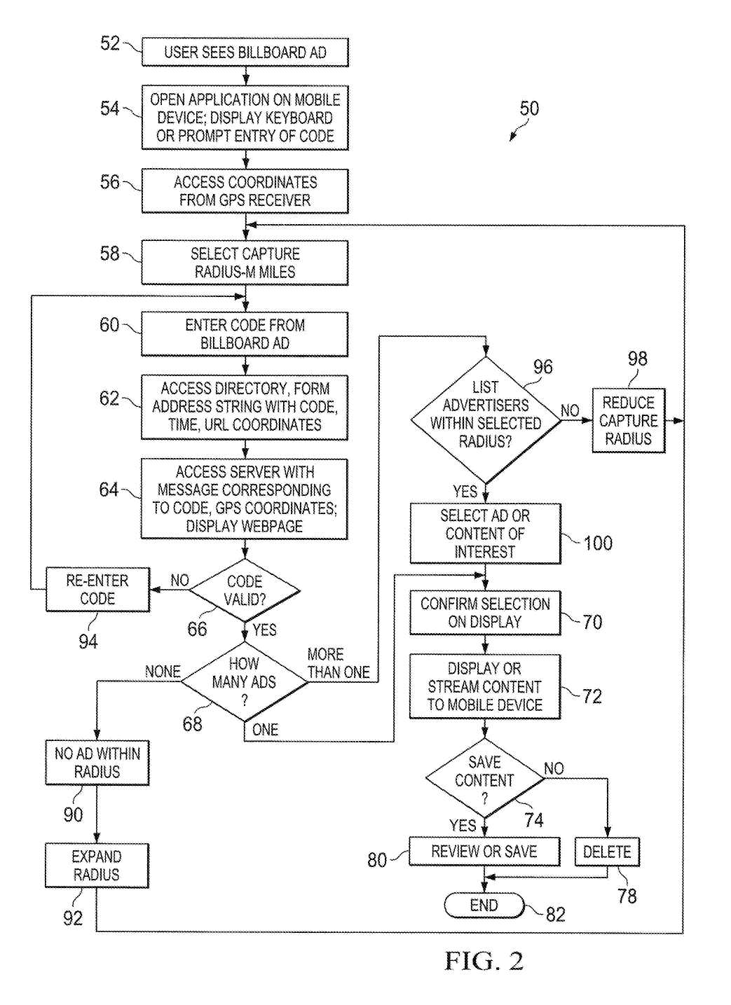

In the illustrated example, the characters of the code 22 may preferably include as few as two numeric or alphabetic characters or perhaps, particularly in large urban areas, up to four characters. For example, two numeric and one or two alphabetic characters may be combined. It is important to keep the code 22 as simple as possible so that it may readily be read, remembered, and entered into the user mobile device 12. In the present example depicted in FIG. 1, the number 29 represents a code 22 that when entered into the user mobile device 12 causes it to access additional information about the displayed advertisement that may be stored in the database 28. This small number of characters is easily remembered by a passing consumer or user, who may then call up the application 14 on the user mobile device 12 and enter the two or three or four characters to initiate access to further details about the displayed advertisement. The advertiser 24 is preferably in communication with a content server 26 via the link E. The content server 26 is linked to the Internet via path C. The content server 26 communicates with the database 28 through a link D. By this means the advertiser can provide and source the content related to its advertisement displayed on the billboard 20 so that it may be accessible to a consumer or user on demand simply by operation of the invention described herein according to the process 50 to be described in conjunction with FIG. 2.

The assignment of codes may be based on several considerations, In the vicinity of small towns or cities and rural areas, two characters will normally be sufficient. In larger regions or metropolitan areas more characters may be required to accommodate the number of advertisers using the service in that region. Nevertheless it is important to minimize the number of characters to ensure accurate relationship between the advertisement and the code entered by the user into his or her mobile device 12. The possibility of reserving certain codes for very large entities may be appropriate. For example, a very large company having a nation-wide presence could reasonably expect to use a two-character code for all of its billboard-type ads nation-wide. Accordingly, the provider of the service that supplies the software that implements the present invention may allocate certain preferred combinations of characters to certain classes of client advertisers. Persons skilled in the art will recognize that numerous combinations of two to four characters exist or can be devised to best represent the advertiser of the billboard display advertisement. A key requirement for selecting the code in a particular instance, besides its availability is that it be easily read, remembered, and entered into the user mobile device 12.

FIG. 2 illustrates a flow chart diagram of one embodiment of the process performed by the system of the present invention illustrated in FIG. 1. The process 50, which is essentially controlled by the application 14 installed in the user mobile device 12, begins at step 52 when the consumer or user sees an advertisement on a billboard 20 of interest that includes a code 22 in the displayed advertisement, perhaps also associated with a logo of a provider of content, and prepares to operate his or her mobile device 12 by opening the application 14 installed on the mobile device 12 in step 54. Step 54 may include the display of graphic means for entering a code 22 such as a keypad or keyboard that may be operated by touching the screen, as is well known. The display may also include a prompt for entering the code. Alternatively, in some mobile devices, a mechanical keyboard or keypad will be provided. Once opened, the application 14 accesses the GPS coordinates of the user mobile device 12 from the GPS receiver 16 in the mobile device 12 in step 56. In an alternative embodiment, step 56 may also optionally include the display of a list of advertisers associated with the GPS coordinates provided by the GPS receiver in the user mobile device 12.

After step 56 the flow then proceeds to enable setting a capture radius relative to the location of the mobile device 12 as determined by the GPS receiver 16 in step 58. This capture radius, which may be set in units of miles or fractions thereof depending on the population density of the region of activity, defines the area in which the application 14 will permit or accept advertiser responses to the entry of the advertiser's code 22 as will be described. In some embodiments, a default capture radius may he pre-set in the software application to be described. The default capture radius is thus presumed if the user takes no action to set a capture radius on his or her user mobile device. Step 58 may include a prompt or query to the user to elect the pre-set capture radius or select an alternative capture radius. It should also be understood that the GPS coordinates of the user mobile device indicate the approximate location of the billboard advertisement to which the user is responding by entering a code 22.

In step 60 the user enters the code 22, for example using a qwerty keyboard or other keyed or spoken mechanism, that is visually read from the advertisement on the billboard 20 as the user passes by the billboard 20. In embodiments that include a voice recognition module 44 (or a separate application installed in the user mobile device 12 and responsive to a call from the application 14), the code 22 may be entered by the user speaking into the user mobile device 12. Next, the application 14 forms an address string in step 62 that preferably may include the URL of the content server 26 and other information such as a time stamp, the advertiser's code 22, and the GPS coordinates for the location of the mobile device 12. Step 62 may include a subroutine in the application 14 for assembling the code 22 entered by the user, the location coordinates and time stamp, and the URL or other address information of the advertiser associated with the code 22, as is well understood by persons skilled in the art.

Step 62 is followed by accessing the content server 26 in step 64 using the information in the address string, whereupon the server 26 may process the message, validate the code 22 in the message in step 66, display the advertiser's web page, etc. If the code 22 checks valid in step 66, the process advances to step 68, a test step to determine how many advertisements are displayed within the capture radius that is set in the user's mobile device 12. If the capture radius is appropriately set in a way that corresponds to the billboard density of the advertiser whose code 22 was entered, then generally one advertisement will be available to the user's mobile device 12 and the application advances to step 70 to select that advertisement as the one of interest to the user. If in step 66, the code entered cannot be validated, then the process loops back through step 94 to re-enter the code for further processing.

Continuing, in step 68, if there is no advertisement corresponding to the entered code 22 within the capture radius, then in step 90 the process may need to loop back through step 92 to expand the capture radius in that particular location so that the region of interest can be enlarged to capture the desired content corresponding to the entered code 22. Further, if in step 68 it is determined that there are more than one advertisement in the area defined by the capture radius, then an opportunity to list advertisers within the selected capture radius may be offered in step 96. If it is preferred to not display the list, then the user may elect to opt out (“NO”) and proceed to step 98 to reduce the capture radius and re-enter the process at step 58. If the user prefers to see a list in step 96 (“YES”), then the process advances to step 100 to select an advertisement or content of interest, followed by step 70 to confirm the selection on the display, i.e., identify a single advertisement corresponding to the code 22 entered by the user. The output of both steps 92 and 98 proceeds to re-enter step 58 to select the new capture radius determined in the respective steps 92 or 98.

Returning to step 70, where presumably the application 14 has advanced to select a single advertisement of interest, the process advances to step 72 to download and display or stream the selected content to the user mobile device 12 for viewing by the user. The user, in step 74 may then decide whether to save the content to the mobile device. If YES then the content may be downloaded for review or to be saved in step 80, or if NO then the content may be deleted in step 78 before the process ends in step 82.

The present invention as described herein provides a user-centric method for accessing advertising content displayed on a billboard panel from a user's mobile communication device having a GPS receiver, comprising the steps of launching an application program installed on the mobile communications device for establishing a link to a content server; accessing location coordinates for the mobile communications device provided from the GPS receiver in the mobile communications device; entering a code, composed of less than five alpha and/or numeric characters displayed in a billboard panel advertisement and associated with the content server, into the user mobile device; associating the code symbol with the location coordinates of the mobile communications device and a URL of a content server associated with the advertising displayed on the billboard panel; connecting the mobile communications device to a content server linked to the advertiser using the URL associated with the code symbol and location coordinates; and downloading content associated with the code from the content server linked to the advertiser to the mobile communications device.

In another embodiment, the invention described herein provides an apparatus for accessing content of an advertiser associated with a code displayed in an advertisement on a billboard panel. The invention provides a mobile communications device having a UPS receiver for obtaining location coordinates and an entry device for entering the code; and an application installed on the mobile communications device for enabling use of the mobile communications device by a user to respond to entry of the code, to form an address string including the location coordinates, the code, and a URL of an advertiser associated with the code, the address string provided to enable the mobile communication device to access a content server on a network associated with the advertiser; wherein entry of the code initiates an operation to download the content associated with the code from the content server for display on the mobile communications device; and wherein the code is limited to less than five alphabetic or numeric characters.

While the invention defined in the appended claims has been shown and described herein in one of its forms, and several aspects or features of the invention have been illustrated by example, the invention is not limited to the exemplary illustrations herein but is susceptible to various alternatives, equivalents, changes and modifications, including the addition of features, without departing from the basic concepts disclosed and claimed herein.

What is claimed is:

1. A user-centric method for accessing content associated with advertising displayed on a billboard panel from a user's mobile communication device having a GPS receiver, comprising the steps of:
launching an application program installed on the mobile communications device for establishing a link to a content server;
accessing location coordinates for the mobile communications device provided from the GPS receiver in the mobile communications device;
entering a code, composed of less than five alpha and/or numeric characters displayed in a billboard panel advertisement and associated with the content server, into the user mobile device;
associating the code with the location coordinates of the mobile communications device and a URL of a content server associated with the advertising displayed on the billboard panel;
connecting the mobile communications device to the content server linked to the advertiser using the URL associated with the code and location coordinates; and
downloading content associated with the code from the content server linked to the advertiser to the mobile communications device.

2. The method of claim 1, further comprising the step of:
selecting the user's mobile communication device from the group consisting of a cellular telephone, a smart telephone, a laptop computer, a tablet computer, and any programmable communications device.

3. The method of claim 1, further comprising the step of:
displaying the downloaded content on the mobile communications device.

4. The method of claim 1, wherein the step of launching comprises the step of:
defining an effective capture area according to a pre-set radius centered on the location of the billboard advertisement.

5. The method of claim 1, wherein the step of launching comprises the step of:
selecting an effective capture area within a radius centered on the location of the billboard advertisement.

6. The method of claim 1, wherein the step of accessing comprises the step of:
keying the application program to obtain location coordinates of the mobile communications device from the GPS receiver.

7. The method of claim 1, wherein the code composed of alphabetic and/or numeric characters corresponding to an advertiser's advertisement is defined by two characters disposed adjacent each other.

8. The method of claim 1, wherein the code composed of alphabetic and/or numeric characters corresponding to an advertiser's advertisement is defined by up to four characters disposed adjacent each other.

9. The method of claim 1, comprising the step of:
entering the code on a keyboard on the user mobile communication device.

10. The method of claim 1, comprising the step of:
entering the code on a touch sensitive keyboard on the user mobile communication device.

11. The method of claim 1, comprising the step of:
entering the code by speaking into the user mobile communication device.

12. the method of claim 11, wherein the code entered into the user mobile communication device is detected by voice recognition software installed in the user mobile communication device.

13. The method of claim 1, wherein the step of associating comprises the step of:
accessing the URL of the content server of the advertiser associated with the code in a memory location in the user mobile device.

14. The method of claim 1, wherein the step of associating comprises the step of:
looking up the code in a directory in the user mobile device to obtain the URL of the content server of the advertiser that is associated with the code entered into the user mobile device.

15. The method of claim 1, wherein the step of connecting to the content server comprises the steps of:
determining if the code entered at the mobile communications device is valid;
selecting content if one advertisement is associated with the defined capture area;
reducing a capture radius if content for more than one advertisement is associated with the defined capture area; and
expanding the capture radius if no content is provided that is associated with the defined capture area.

16. The method of claim 1, wherein the step of downloading comprises the steps of:
selecting the content if a single advertisement is displayed;
expanding the capture radius if no content is displayed; and
contracting the capture radius if more than one item of content is displayed.

17. The method of claim 3, further comprising the step of:
saving the content using the mobile communications device.

18. An apparatus for accessing advertising content of an advertiser associated with a code displayed in a advertisement on a billboard panel, comprising:
a mobile communications device having a GPS receiver for obtaining location coordinates and an entry device for entering the code; and
an application installed on the mobile communications device for enabling use of the mobile communications device by a user to respond to entry of the code, to form an address string including the location coordinates, the code, and a URL of a content server associated with the code, the address string provided to enable the mobile communication device to access the content server on a network associated with the advertiser; wherein
entry of the code initiates an operation to download the advertising content associated with the code from the content server for display on the mobile communications device; and wherein
the code is limited to less than five alphabetic or numeric characters.

19. The apparatus of claim 18, wherein the entry device comprises:
a mechanism selected from the list consisting of a keyboard, a keypad, a keyboard or keypad or graphic symbol or icon configured as an image displayed on a touch sensitive screen, and a voice recognition module.

20. the apparatus of claim 18, wherein the application comprises:
a voice recognition module for receiving entry of spoken code characters.

21. The apparatus of claim 18, wherein the code comprises:
two alphabetic or numeric characters of any language in any combination.
